(19) United States
(12) Patent Application Publication
(10) Pub. No.: US 2023/0238729 A1
(43) Pub. Date: Jul. 27, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Teruo HARA, Mie (JP); Hajime MATSUI, Mie (JP)

(21) Appl. No.: 18/010,135

(22) PCT Filed: Jun. 4, 2021
(86) PCT No.: PCT/JP2021/021303

§ 371 Date: Dec. 13, 2022

(30) Foreign Application Priority Data
Jun. 25, 2020 (JP) 2020-109372

(51) Int. Cl. H01R 13/424

(52) U.S. Cl. CPC H01R 13/424

(57) ABSTRACT

A connector 10 is provided with a terminal 20 to be connected to a front end part of a wire 11 extending in a front-rear direction, a connector housing 40 including an accommodating portion 41 for accommodating the terminal 20, and a rear holder 50 to be mounted on a rear end part of the connector housing 40. The rear holder 50 is formed with an insertion hole 61 extending along an extending direction of the wire between a communication opening 61A communicating with the accommodating portion 41 and a rear opening 61B open to outside in a rear end part of the rear holder 50. A guiding inclined surface 62 for reducing a hole diameter of the insertion hole 61 toward the communication opening 61A is provided on a wall surface of the insertion hole 61.

### TECHNICAL FIELD

The present disclosure relates to a connector.

### BACKGROUND

Patent Document 1 below discloses a connector provided with a terminal to be connected to a front end part of a wire, a connector housing including an accommodating portion for accommodating the terminal and a rear holder to be mounted on a rear side of the connector housing. The rear holder includes an insertion hole communicating with the accommodating portion in a state mounted on the connector housing, and the terminal is composed of two components including a terminal body and a slide portion disposed behind the terminal body. To connect the wire to the terminal accommodated in the accommodating portion, the wire is inserted through the insertion hole of the rear holder and brought to the slide portion of the terminal and further into the terminal body and, thereafter, the slide portion is slid forward. In this way, a pressurizing portion of the slide portion presses a sandwiching portion of the terminal body toward a core wire and the core wire is crimped and connected to the terminal body.

### PRIOR ART DOCUMENT

### Patent Document

Patent Document 1: JP 2019-145208 A

### SUMMARY OF THE INVENTION

### Problems to Be Solved

In the connector provided with the terminal as described above, the wire is inserted and connected to the terminal accommodated in the connector housing through the rear holder. Thus, a structure for easily introducing the wire into the terminal from the rear holder is desired.

A technique disclosed in this specification was completed on the basis of the above situation and aims to provide a connector improved in the efficiency of an operation of inserting a wire into a terminal.

### Means to Solve the Problem

The present disclosure is directed to a connector with a terminal to be connected to a front end part of a wire extending in a front-rear direction, a connector housing including an accommodating portion for accommodating the terminal, and a rear holder to be mounted on a rear end part of the connector housing, the rear holder being formed with an insertion hole extending along the extending direction between a communication opening communicating with the accommodating portion and a rear opening open to outside in a rear end part of the rear holder, and a guiding inclined surface for reducing a hole diameter of the insertion hole toward the communication opening being provided on a wall surface of the insertion hole.

### Effect of the Invention

According to the present disclosure, it is possible to provide a connector improved in the efficiency of an operation of inserting a wire into a terminal.

### BRIEF DESCRIPTION OF THE DRAWINGS

FIG. 1 is a perspective view showing the appearance of a connector according to an embodiment.

FIG. 2 is a perspective view partly in section schematically showing the connector.

FIG. 3 is a section showing the connector after wire connection (in a state where lid portions and rear lid portions of a rear holder are closed).

FIG. 4 is a perspective view showing a terminal.

FIG. 5 is a perspective view showing a connector housing.

FIG. 6 is a perspective view showing the rear holder (in the state where the lid portions and the rear lid portions are closed).

FIG. 7 is a perspective view enlargedly showing a part of the rear holder (in the state where the lid portions and the rear lid portions are closed).

FIG. 8 is a section showing the connector after wire connection (in a state where the lid portions and the rear lid portions of the rear holder are opened).

FIG. 9 is a perspective view showing the rear holder (in the state where the lid portions and the rear lid portions are opened).

FIG. 10 is a perspective view enlargedly showing a part of the rear holder (in the state where the lid portions and the rear lid portions are opened).

### DETAILED DESCRIPTION TO EXECUTE THE INVENTION

### Description of Embodiments of Present Disclosure

First, embodiments of the present disclosure are listed and described.

(1) The connector of the present disclosure is provided with a terminal to be connected to a front end part of a wire extending in a front-rear direction, a connector housing including an accommodating portion for accommodating the terminal, and a rear holder to be mounted on a rear end part of the connector housing, the rear holder being formed with an insertion hole extending along an extending direction of the wire between a communication opening communicating with the accommodating portion and a rear opening open to outside in a rear end part of the rear holder, and a guiding inclined surface for reducing a hole diameter of the insertion hole toward the communication opening being provided on a wall surface of the insertion hole.

According to the configuration of (1) described above, in the case of inserting and connecting the wire to the terminal accommodated in the accommodating portion of the connector housing through the insertion hole of the rear holder, the wire inserted into the insertion hole through the rear opening of the rear holder can be smoothly introduced to the communication opening by the guiding inclined surface and further into the terminal. As a result, the efficiency of an operation of inserting the wire into the terminal is improved.

(2) Preferably, the rear holder includes a lid portion capable of opening and closing the insertion hole in an intersecting direction intersecting the extending direction, and a holder body portion for forming the insertion hole together with the lid portion with the lid portion closed.

According to the configuration of (2) described above, by opening the lid portion to allow the insertion hole to at least partially communicate with outside in the intersecting direction when needed while normally closing the lid portion to protect the wire in the insertion hole, the cutting, repair or the like of the wire disposed in the insertion hole can be performed from the intersecting direction. In this way, even if the connector is, for example, so structured that the rear holder cannot be removed from the connector housing after the wire is connected to the terminal in the accommodating portion, it is possible to separate the terminal and the wire by opening the lid portion of the rear holder and cutting the wire from the intersecting direction and pull out the wire rearward from the rear holder.

(3) Preferably, a rear end part of the terminal accommodated in the accommodating portion is covered by the lid portion with the lid portion closed and is exposed in the intersecting direction with the lid portion opened, and the terminal is accommodated in the accommodating portion removably in the intersecting direction with the lid portion opened.

According to the configuration of (3) described above, a connected part of the terminal and the wire can be normally protected by closing the lid portion, whereas the lid portion can be opened and the terminal cut off from the wire can be taken out in the intersecting direction when needed. As a result, each of the terminal and the wire can be easily taken out from the connector and the terminal or wire can be exchanged or repaired.

(4) Preferably, the lid portion is coupled to the holder body portion by a hinge portion.

According to the configuration of (4) described above, the lid portion can be easily opened and closed if necessary while a loss or position shift of the lid portion is suppressed by a simple configuration.

(5) Preferably, the lid portion includes a lid-side wall portion constituting a part of the wall surface of the insertion hole with the lid portion closed, the holder body portion includes a body-side wall portion constituting the wall surface of the insertion hole together with the lid-side wall portion with the lid portion closed, and one of the lid portion or the holder body portion is formed with a wall receiving portion, the body-side wall portion or the lid-side wall portion being press-fit into the wall receiving portion with the lid portion closed.

According to the configuration of (5) described above, the lid portion can be stably maintained in the closed state even without separately providing a locking mechanism by press-fitting the body-side wall portion or lid-side wall portion into the wall receiving portion.

### Details of Embodiment of Present Disclosure

An embodiment of the present disclosure is described below. The present invention is not limited to these illustrations, but is represented by claims, and is intended to include all changes in the scope of claims and in the meaning and scope of equivalents.

### Embodiment

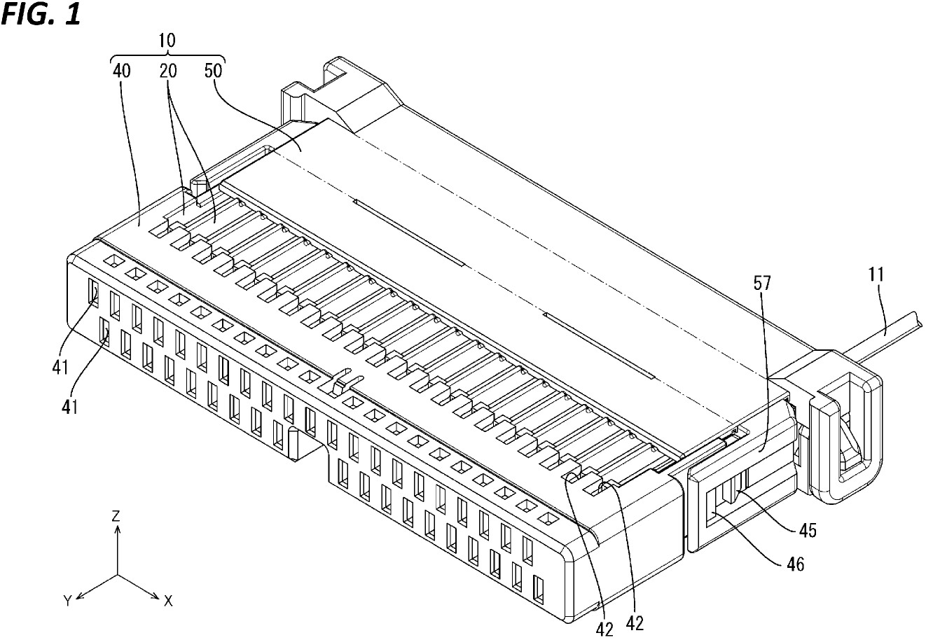

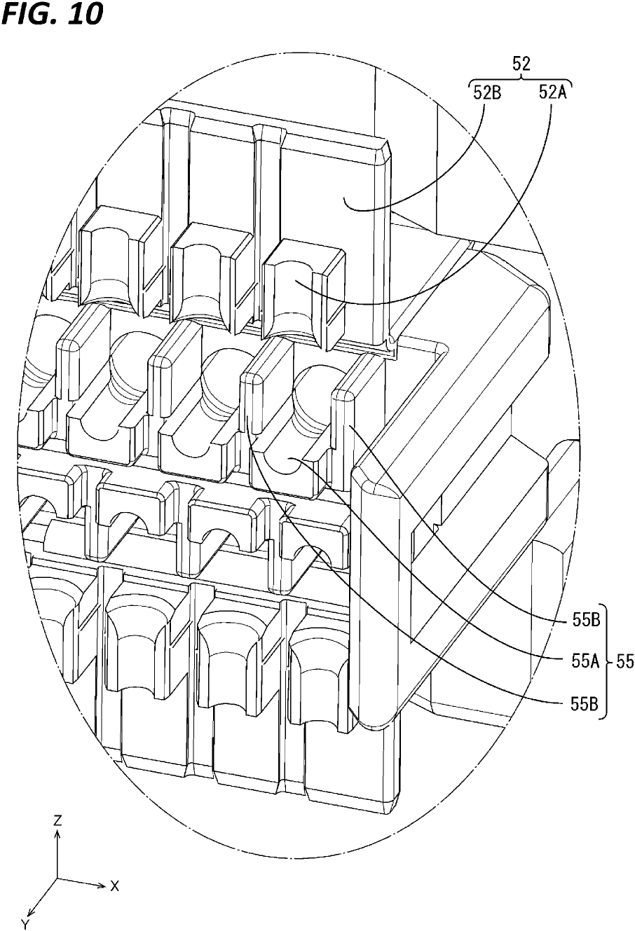

The embodiment of the present disclosure is described with reference to FIGS. 1 to 10. In the following description, directions indicated by arrows Z, Y and X shown in each figure are respectively referred to as an upward direction, a forward direction and a leftward direction. Note that, for a plurality of identical members, only some members may be denoted by a reference sign and the other members may not be denoted by the reference sign.

### Connector 10

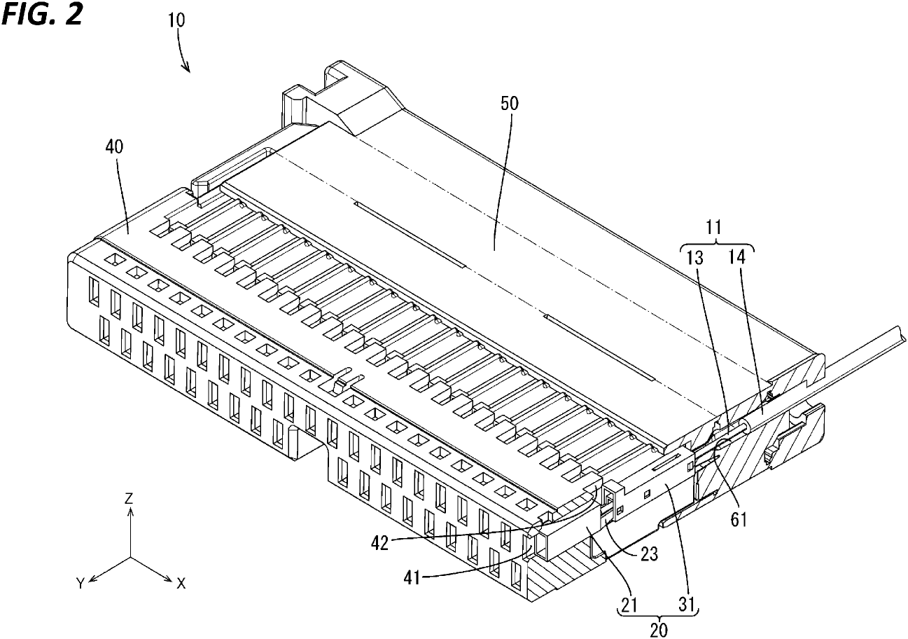

As shown in FIGS. 1 and 2, a connector 10 according to this embodiment is provided with terminals 20 to be connected to wires 11, a connector housing 40 including a plurality of accommodating portions 41 for accommodating a plurality of the terminals 20 and a rear holder 50 to be assembled with the connector housing 40.

### Wire 11

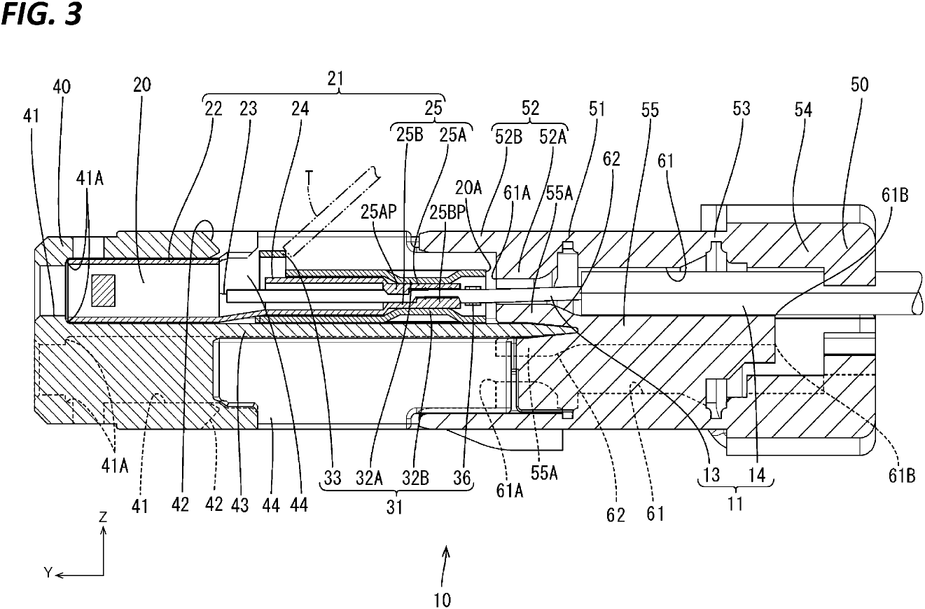

As shown in FIGS. 2 and 3, the wire 11 is disposed to extend in a front-rear direction. The wire 11 includes a core wire 13 and an insulation coating 14 made of insulating synthetic resin for surrounding the outer periphery of the core wire 13. The core wire 13 according to this embodiment is constituted by one metal wire. Note that the core wire 13 may be a stranded wire obtained by stranding a plurality of thin metal wires. An arbitrary metal such as copper, copper alloy, aluminum or aluminum alloy can be appropriately selected as a metal constituting the core wire 13 if necessary. The core wire 13 according to this embodiment is made of copper or copper alloy. The wire 11 is inserted into the connector 10 in a state where the insulation coating 14 is stripped in a front end to expose the core wire 13, and the exposed core wire 13 is crimped to the terminal 20 accommodated in the connector housing 40.

### Terminal 20

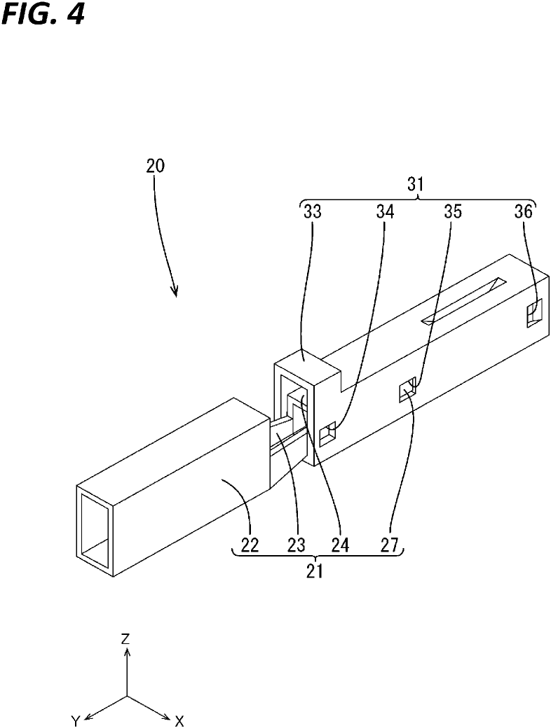

As shown in FIG. 4 and the like, the terminal 20 includes a terminal body 21 made of metal and a slide member 31 relatively slidable with respect to the terminal body 21.

### Terminal Body 21

The terminal body 21 is formed by shearing and bending a metal plate material. An arbitrary metal such as copper, copper alloy, aluminum, aluminum alloy or stainless steel can be appropriately selected as a metal constituting the terminal body 21 if necessary. The terminal body 21 according to this embodiment is made of copper or copper alloy. A plating layer may be formed on the surface of the terminal body 21. An arbitrary metal such as tin, nickel or silver can be appropriately selected as a metal constituting the plating layer if necessary. Tin plating is applied to the terminal body 21 according to this embodiment.

As shown in FIGS. 3 and 4, the terminal body 21 includes a tube portion22 into which an unillustrated mating terminal is insertable, a terminal window portion 23 located behind the tube portion 22, a base portion 24 located behind the terminal window portion 23 and a connecting portion 25 located behind the base portion 24.

As shown in FIG. 4 and the like, the tube portion 22 is in the form of a rectangular tube extending in the front-rear direction. As shown in FIG. 4, the front end of the tube portion 22 is open so that the mating terminal is insertable thereinto. An unillustrated resilient contact piece is disposed inside the tube portion 22. The resilient contact piece resiliently contacts the mating terminal inserted into the tube portion 22, whereby the tube portion 22 and the mating terminal are electrically connected.

As shown in FIG. 4 and the like, the terminal window portion 23 open upward is provided at a position behind the tube portion 22 and in front of the base portion 24. As shown in FIG. 3, a front end part of the core wire 13 can be detected from outside through the terminal window portion 23 with the core wire 13 disposed in a space between an upper connection piece 25A and a lower connection piece 25B to be described later.

As shown in FIG. 4 and the like, the base portion 24 provided behind the terminal window portion 23 is in the form of a rectangular tube. Locking projections 27 projecting outward are provided on left and right side walls of the base portion 24, and are lockable to partial lock receiving portions 34 or full lock receiving portions 35 of the slide member 31 to be described later (see FIG. 4).

As shown in FIG. 3, the upper connection piece 25A constituting the connecting portion 25 is provided to extend rearward from the rear end of the upper wall of the base portion 24, and the lower connection piece 25B likewise constituting the connecting portion 25 is provided to extend rearward from the rear end of the lower wall. Both the upper and lower connection pieces 25A, 25B are in the form of cantilevers having a shape elongated in the front-rear direction and having a tip side resiliently deformable in a vertical direction with the rear end of the base portion 24 as a fulcrum. As shown in FIG. 3, an upper holding protrusion 25AP projecting downward is provided at a position near the base portion 24 on the lower surface of the upper connection piece 25A. Further, a lower holding protrusion 25BP projecting upward is provided in a rear end part of the upper surface of the lower connection piece 25B. In the connecting portion 25, the upper and lower holding protrusions 25AP, 25BP are provided at positions shifted from each other in the front-rear direction, specifically provided such that the front end of the lower holding protrusion 25BP is located behind the rear end of the upper holding protrusion 24AP. Note that serration may be applied to the lower surface of the upper connection piece 25A and the upper surface of the lower connection piece 25B.

### Slide Member 31

As shown in FIG. 4 and the like, the slide member 31 is in the form of a rectangular tube extending in the front-rear direction. The slide member 31 is formed into a predetermined shape by a known technique such as press-working, cutting or forging. An arbitrary metal such as copper, copper alloy, aluminum, aluminum alloy or stainless steel can be appropriately selected as a metal constituting the slide member 31 if necessary. Although not particularly limited, the slide member 31 according to this embodiment is made of stainless steel. A plating layer may be formed on the surface of the slide member 31. An arbitrary metal such as tin, nickel or silver can be appropriately selected as a metal constituting the plating layer if necessary.

As shown in FIG. 4 and the like, a jig contact portion 33 projecting upward is formed in a front part of the upper wall of the slide member 31. As shown in FIG. 3, a jig T can be brought into contact with the jig contact portion 33 from behind. If the terminal 20 is accommodated into the accommodating portion 41 of the connector housing 40 to be described later and the jig T is brought into contact with the jig contact portion 33 and pushed forward, the slide member 31 moves forward in the accommodating portion 41. Since the terminal body 21 is accommodated in the accommodating portion 41 immovably forward by a recess 41A to be described later, the slide member 31 relatively moves with respect to the terminal body 21. Note that the jig T is relatively smaller in size than a mold and a facility for operating this mold. Thus, a cost increase resulting from the jig T is suppressed.

As shown in FIG. 3, an upper pressurizing portion 32A projecting downward is provided in a rear side part of the upper wall of the slide member 31. A lower pressurizing portion 32B projecting upward is provided at a position facing the upper pressurizing portion 32A on the lower wall of the slide member 31. Inclined surfaces are formed on front end parts of the upper and lower pressurizing portions 32A, 32B. In this way, a rear end part of the upper connection piece 25A and that of the lower connection piece 25B are respectively guided to a position below the upper pressurizing portion 32A and a position above the lower pressurizing portion 32B.

As shown in FIG. 4, the partial lock receiving portion 34 is open at a front side position in the front-rear direction in each side wall of the slide member 31. Further, the full lock receiving portion 35 is open at a position behind the partial lock receiving portion 34 in each side wall of the slide member 31. The locking projections 27 provided on the right and left side walls of the terminal body 21 are resiliently lockable to the partial lock receiving portions 34 and the full lock receiving portions 35. In this way, the slide member 31 is slidable in the front-rear direction between the partial locking position and the full locking position described above while being externally fit to a region of the terminal body 21 where the upper and lower connection pieces 25A, 25B are provided.

With the locking projections 27 of the terminal body 21 and the partial lock receiving portions 34 of the slide member 31 locked, the slide member 31 is held at the partial locking position with respect to the terminal body 21. In this state, the upper and lower pressurizing portions 32A, 32B of the slide member 31 are located behind the rear ends of the upper and lower connection pieces 25A, 25B of the terminal body 21. Further, in this state, an interval between the upper and lower connection pieces 25A, 25B is set larger than a diameter of the core wire 13.

With the locking projections 27 of the terminal body 21 and the full lock receiving portions 35 of the slide member 31 locked, the slide member 31 is held at the full locking position with respect to the terminal body 21 (see FIG. 3 and the like). In this state, the upper pressurizing portion 32A of the slide member 31 presses the upper connection piece 25A from above. The lower pressurizing portion 32B of the slide member 31 presses the lower connection piece 25B from below.

As shown in FIG. 4 and the like, a pair of guiding portions 36 projecting inwardly of the slide member 31 are provided on the both left and right side walls at rear side positions of the slide member 31. The guiding portion 36 is formed to become narrower from rear to front. The core wire 13 slides in contact with the inner surfaces of the guiding portions 36, whereby the core wire 13 is guided into the slide member 31.

### Connector Housing 40

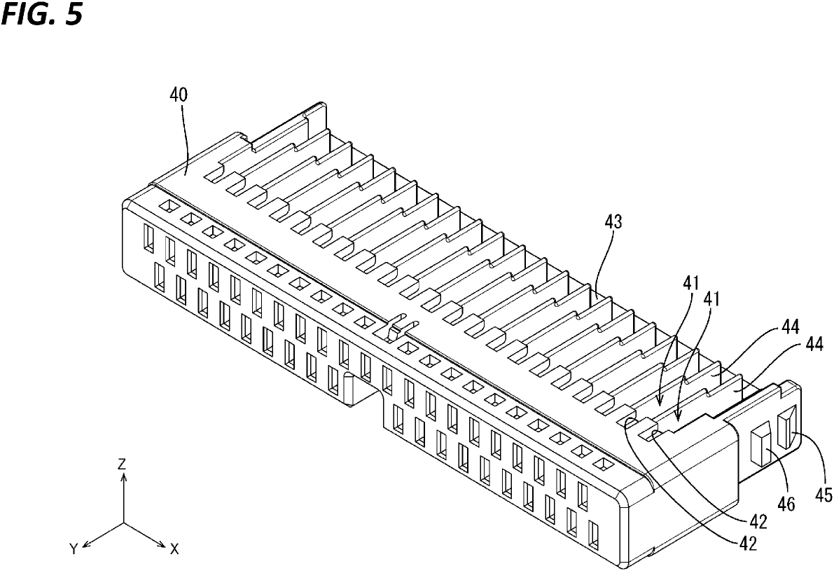

As shown in FIG. 5 and the like, the connector housing 40 has a substantially rectangular parallelepiped shape flat in the vertical direction and extending in a lateral direction. The connector housing 40 is formed by injection-molding an insulating synthetic resin. In the connector housing 40, the plurality of accommodating portions 41 extending in the front-rear direction for accommodating the terminals 20 are arranged side by side at intervals in the lateral direction and in two upper and lower stages. The respective accommodating portions 41 formed in the lower stage and those formed in the upper stage are disposed at laterally shifted positions. Note that the number of the accommodating portions 41 is arbitrary and the number of the stages arranged in the vertical direction is also arbitrary.

As shown in FIGS. 3, 5 and the like, the front end of the accommodating portion 41 is open forward, and the mating terminal is insertable into the accommodating portion 41. Further, as shown in FIG. 5 and the like, the rear end of the accommodating portion 41 is open rearward and the terminal 20 can be accommodated into the accommodating portion 41 from behind. As shown in FIG. 3, the recess 41A shaped in conformity with a front end corner part of the aforementioned tube portion 22 is formed in a front end part of the accommodating portion 41. If the terminal 20 is inserted and accommodated into the accommodating portion 41 from behind, a forward movement of the terminal body 21 is restricted by the recess 41A.

As shown in FIGS. 2, 5 and the like, the accommodating portion 41 is formed with a connector window portion 42 communicating with outside in a region from a position corresponding to the terminal window portion 23 of the terminal body 21 with the terminal 20 accommodated to a rear end. The terminal window portion 23 of the terminal 20 accommodated in the accommodating portion 41 can be detected from the outside of the connector 10 through this connector window portion 42. In this way, a front end part of the core wire 13 connected to the terminal 20 can be detected from outside through the connector window portion 42 and the terminal window portion 23. Further, a front end part of the slide member 31 externally fit to the base portion 24 of the terminal body 21 is exposed to outside by the connector window portion 42. In this way, as shown in FIG. 3, the slide member 31 can be slid forward by bringing the jig T into contact with the jig contact portion 33 of the terminal 20 accommodated in the accommodating portion 41.

As shown in FIGS. 3 and 5, the connector housing 40 includes a separation wall 43 partitioning between the accommodating portions 41 formed in the upper stage and those formed in the lower stage. The separation wall 43 extends rearward from the rear ends of the accommodating portions 41. By this separation wall 43, the terminals 20 accommodated in the accommodating portions 41 adjacent in the vertical direction are electrically insulated from each other. Further, partition walls 44 extending in the front-rear direction and vertically projecting are provided respectively on the upper and lower surfaces of the separation wall 43. The terminals 20 accommodated in the accommodating portions 41 adjacent in the lateral direction are electrically insulated from each other by this partition wall 44.

As shown in FIG. 5, partial locking portions 45 projecting outward are provided at positions near rear ends of both left and right side walls of the connector housing 40, and full locking portions 46 likewise projecting outward are provided at positions forward of the partial locking portions 45.

### Rear Holder 50

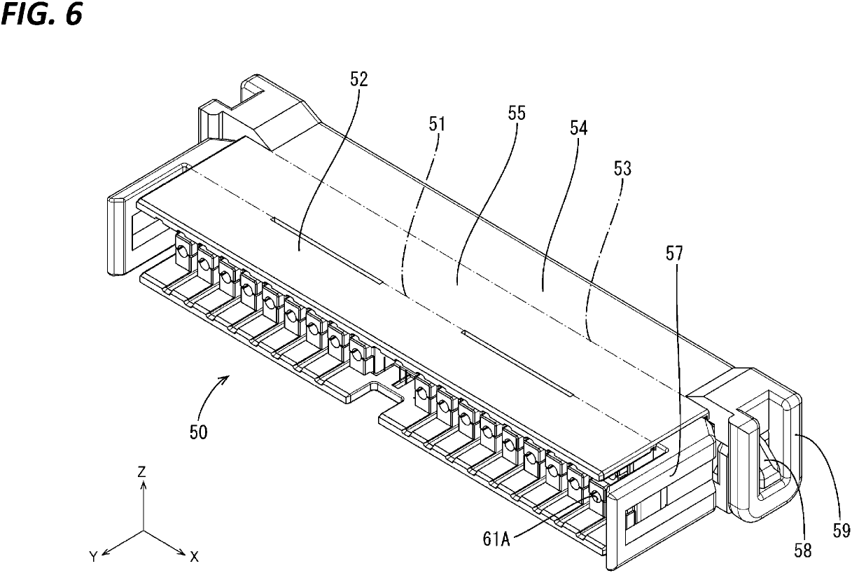

As shown in FIG. 6 and the like, the rear holder 50 has a substantially rectangular parallelepiped shape flat in the vertical direction and extending in the lateral direction. The rear holder 50 is formed by injection-molding an insulating synthetic resin. The rear holder 50 is externally fit to a rear end part of the connector housing 40. Lock receiving portions 57 resiliently locked to the partial locking portions 45 and the full locking portions 46 of the connector housing 40 are provided at positions near front end parts of both left and right side walls of the rear holder 50. The lock receiving portion 57 is substantially gate-shaped.

By locking the partial locking portions 45 of the connector housing 40 and the lock receiving portions 57 of the rear holder 50, the rear holder 50 is held at a partial locking position with respect to the connector housing 40. Further, by locking the full locking portions 46 of the connector housing 40 and the lock receiving portions 57 of the rear holder 50 as shown in FIG. 1, the rear holder 50 is held at a full locking position with respect to the connector housing 40.

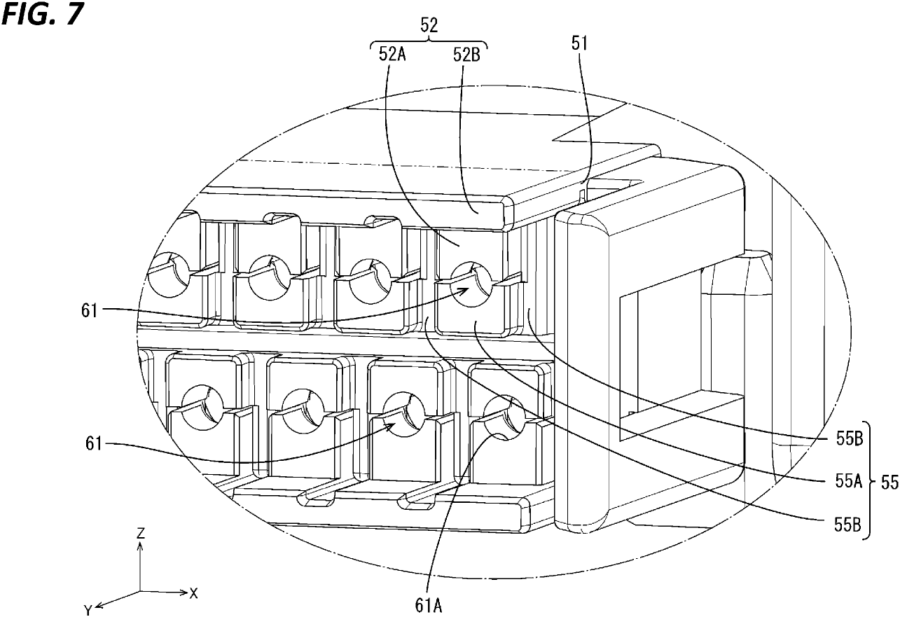

As shown in FIG. 7 and the like, the rear holder 50 is provided with a plurality of insertion holes 61 into which the wires 11 are inserted and which are arranged in parallel in the lateral direction and in two upper and lower stages. The insertion hole 61 is provided at a position corresponding to the accommodating portion 41 of the connector housing 40. As shown in FIG. 3 and the like, the insertion hole 61 is formed to extend in the front-rear direction. The insertion hole 61 extends between a communication opening 61A open on a front side of the rear holder 50 and communicating with the accommodating portion 41 with the rear holder 50 mounted on the connector housing 40 and a rear opening 61B open to outside on a rear side of the rear holder 50. As shown in FIG. 3 and the like, the wire 11 is disposed inside the insertion hole 61 and connected to the terminal 20 in the accommodating portion 41.

As shown in FIG. 3 and the like, a guiding inclined surface 62 for reducing a hole diameter of the insertion hole 61 from the side of the rear opening 61B toward the communication opening 61A is provided on a wall surface of the insertion hole 61. In this embodiment, the guiding inclined surface 62 is provided at a position near the communication opening 61A of the insertion hole 61. In this embodiment, the wall surface of the insertion hole 61 on a side where the guiding inclined surface 62 is provided is formed to be smoothly continuous from the rear opening 61B to the communication opening 61A through the guiding inclined surface 62. By pushing the core wire 13 along the wall surface formed in this way, the core wire 13 can be smoothly introduced into the communication opening 61A.

As shown in FIG. 3 and the like, an opening area of the communication opening 61A is set smaller than that of the rear opening 61B in this embodiment. In this embodiment, the communication opening 61A and the rear opening 61B have circular shapes in conformity with cross-sectional shapes of the wire 11 and the core wire 13. In this embodiment, the terminal 20 is crimped to the core wire 13 by inserting the wire 11 into the insertion hole 61 with the insulation coating 14 stripped in the front end to expose the core wire 13 and bringing only the exposed part of the core wire 13 into the terminal 20 accommodated in the accommodating portion 41. If the terminal 20 and the wire 11 are connected in this way, a diameter of the communication opening 61A is preferably equal to or larger that of the core wire 13, e.g. 1.0 to 2.0-fold of the diameter of the core wire 13, more particularly 1.3 to 1.6-fold of the diameter of the core wire 13. On the other hand, a diameter of the rear opening 61B is preferably equal to or larger than a diameter of the wire 11 including the insulation coating 14, e.g. 1.5 to 3.5-fold of the diameter of the wire 11, more particularly 2.7 to 3.0-fold of the diameter of the wire 11. Within such ranges, the wire 11 can be easily inserted through the rear opening 61B and the core wire 13 exposed in the front end of the wire 11 can be easily introduced into the terminal 20 accommodated in the accommodating portion 41 through the communication opening 61A. As shown in FIG. 3 and the like, a hole diameter (diameter) of the insertion hole 61 at a position forward of the guiding inclined surface 62 is smaller than the diameter of the wire 11 including the insulation coating 14 in this embodiment.

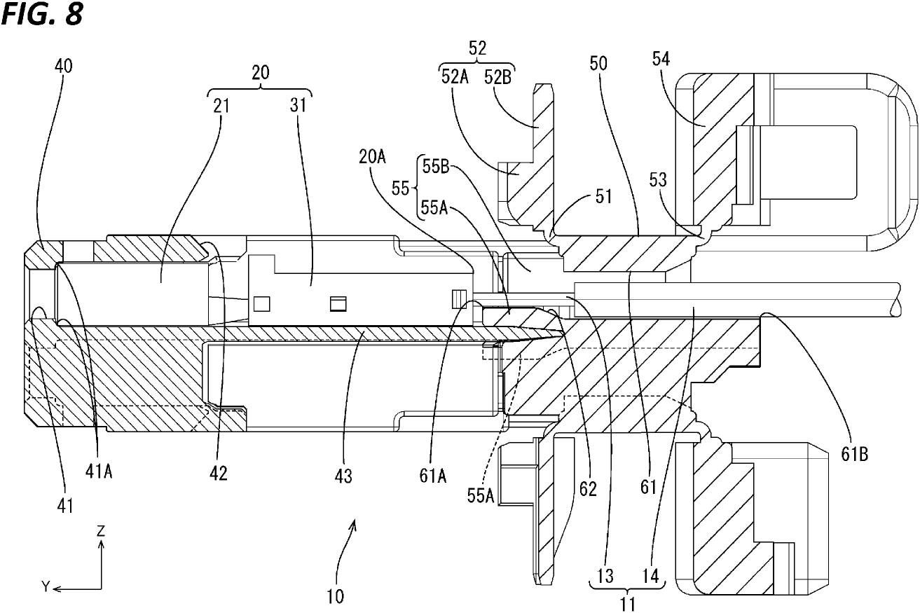

As shown in FIG. 6 and the like, the upper and lower walls of the rear holder 50 are provided with lid portions 52 capable of opening and closing front end parts of the upper and lower walls upward or downward. The lid portion 52 is coupled to a holder body portion 55 via a hinge portion 5. The upper and lower walls of the rear holder 50 are also provided with rear lid portions 54 capable of opening and closing rear end parts of the upper and lower walls upward or downward. The rear lid portion 54 is coupled to the holder body portion 55 via a rear hinge portion 53. As shown in FIGS. 3, 8 and the like, the hinge portion 51 and the rear hinge portion 53 bendably couple the lid portion 52 and the rear lid portion 54 to the holder body portion 55 by partially thinning the upper or lower wall of the rear holder 50. As shown in FIGS. 3, 8 and the like, the insertion holes 61 in the rear holder 50 can be opened and closed in the vertical direction (intersecting direction) intersecting the front-rear direction, which is an extending direction of the wires 11, by the lid portions 52 coupled to the holder body portion 55 via the hinge portions 51. Note that, as shown in FIG. 3 and the like, the hinge portion 51 is provided at a position facing the guiding inclined surfaces 62 across the insertion holes 61 in this embodiment.

As shown in FIGS. 7 to 10 and the like, the lid portion 52 formed in the front end part of the rear holder 50 includes lid-side wall portions 52A and a receptacle 52B. As also shown in FIG. 3, the lid-side wall portions 52A constitute parts of wall surfaces of the insertion holes 61 in a closed state of the lid portion 52. The receptacle 52B is formed to protrude forward above or below the communication openings 61A in the closed state of the lid portion 52. Further, as shown in FIGS. 7 to 10 and the like, the holder body portion 55 includes body-side wall portions 55A and wall receiving portions 55B. The body-side wall portions 55A form the insertion holes 61 together with the lid-side wall portions 52A in the closed state of the lid portion 52. Further, as shown in FIG. 7 and the like, if the lid portion 52 is closed, each lid-side wall portion 52A is press-fit into between the wall receiving portions 55B provided on left and right sides of the body-side wall portion 55A corresponding to the lid-side wall portion 52A while receiving a constant force.

As shown in FIG. 7 and the like, in the rear holder 50, the body-side wall portions 55A forming the insertion holes 61 in the upper stage and those forming the insertion holes 61 in the lower stage are disposed apart from each other in the vertical direction. A part between the lid-side wall portions 52A in the upper stage and those in the lower stage is recessed rearward, and an interval in the vertical direction is set equal to or somewhat larger than a vertical thickness of the separation wall 43 of the connector housing 40 described above. As shown in FIGS. 3 and 8, with the rear holder 50 held at the full locking position with respect to the connector housing 40, the separation wall 43 of the connector housing 40 is fit between the body-side wall portions 55A in the upper stage and those in the lower stage. In this way, a position shift of the rear holder 50 in the vertical direction with respect to the connector housing 40 is suppressed.

As shown in FIG. 3, with the rear holder 50 held at the full locking position with respect to the connector housing 40 and the lid portions 52 closed, rear ends 20A of the terminals 20 accommodated in the accommodating portions 41 of the connector housing 40 are covered from above or below by the receptacles 52B. Further, as shown in FIG. 8, with the rear holder 50 held at the full locking position with respect to the connector housing 40 and the lid portions 52 opened, the rear ends 20A of the terminals 20 accommodated in the accommodating portions 41 of the connector housing 40 are exposed upward or downward. In this embodiment, a length in the front-rear direction of the openable and closable lid portion 52 (distance from the front end of the receptacle 52B to the hinge portion 51) is set equivalent to a length of a front end part of the terminal 20 covered by the upper wall of the connector housing 40 (length in the front-rear direction of the tube portion 22). In this way, if the lid portion 52 is opened and the terminal 20 accommodated in the accommodating portion 41 is slid rearward, the terminal 20 can be taken out upward or downward while the rear holder 50 is maintained at the full locking position with respect to the connector housing 40.

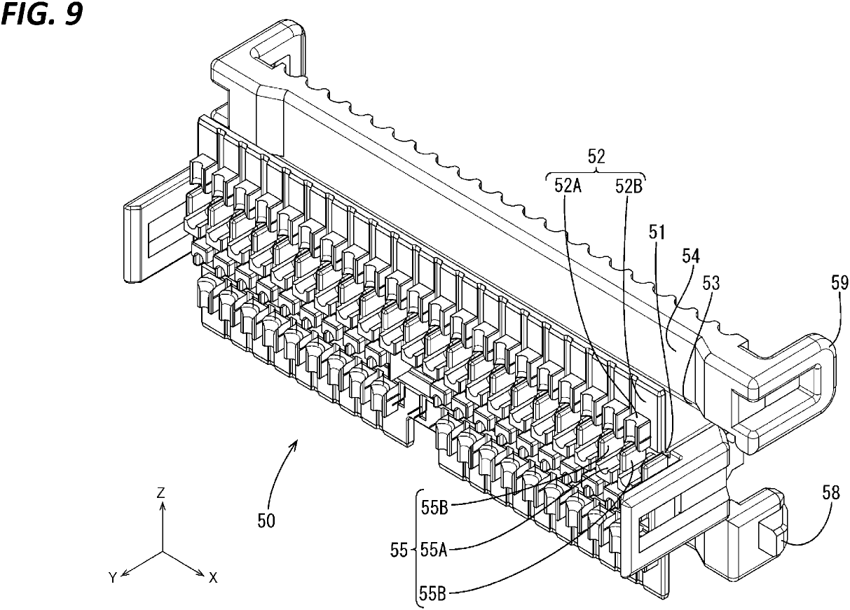

As shown in FIGS. 6 and 9, rear lid locking mechanisms for locking the rear lid portions 54 are provided on left and right ends of the rear lid portions 54 provided in the rear end part of the rear holder 50. In this embodiment, rear lid lock portions 58 projecting outward are provided on the left and right ends of the rear lid portion 54 provided in the lower wall of the rear holder 50, and substantially gate-shaped rear lid lock receiving portions 59 are provided on the left and right ends of the rear lid portion 54 provided in the upper wall. As shown in FIG. 6, the rear lid lock receiving portions 59 are resiliently lockable to the rear lid lock portions 58 with the rear lid portions 54 provided in the upper and lower walls closed. By providing the rear lid portions 54, the insertion of the wires 11 into the rear holder 50 is facilitated. Further, by providing the rear lid locking mechanisms, the rear lid portions 54 can be stably maintained in the closed state and insertion base parts of the wires 11 extending rearward from the rear openings 61B can be protected after the wires 11 are inserted and connected.

### Assembling Process of Connector 10

Next, an example of an assembling process of the connector 10 according to this embodiment is described. The assembling process of the connector 10 is not limited to the one described below.

The terminal body 21 and the slide member 31 are formed by a known technique, and the slide member 31 is assembled with the terminal body 21 from behind. If the front end edge of the slide member 31 comes into contact with the locking projections 27 of the terminal body 21 from behind, the side walls of the slide member 31 are expanded and deformed. If the slide member 31 is pushed further forward, the locking projections 27 of the terminal body 21 are locked to the partial lock receiving portions 34 of the slide member 31 and the side walls of the slide member 31 are restored and deformed. In this way, the terminal 20 is obtained in which the slide member 31 is held at the partial locking position with respect to the terminal body 21.

By injection-molding the synthetic resin, the connector housing 40 and the rear holder 50 are formed, and the terminals 20 are inserted into the accommodating portions 41 of the connector housing 40 from behind.

The rear holder 50 is assembled with the rear end part of the connector housing 40 from behind. If the lock receiving portions 57 of the rear holder 50 come into contact with the partial locking portions 45 of the connector housing 40 from behind, the lock receiving portions 57 of the rear holder 50 are expanded and deformed. If the rear holder 50 is pushed further forward, the partial locking portions 45 of the connector housing 40 are resiliently locked to the lock receiving portions 57 of the rear holder 50 and the lock receiving portions 57 of the rear holder 50 are restored and deformed. In this way, the rear holder 50 is held at the partial locking position with respect to the connector housing 40.

By stripping the insulation coating 14 in the front end of the wire 11, the core wire 13 is exposed over a predetermined length. A front end part of the wire 11 with the exposed core wire 13 is inserted into the insertion hole 61 through the rear opening 61B in the rear end part of the rear holder 50.

If the wire 11 is pushed further forward, the front end part of the core wire 13 passes through the insertion hole 61 of the rear holder 50, projects forward from the communication opening 61A while being guided by the guiding inclined surface 62, and is introduced into the slide member 31 accommodated in the accommodating portion 41. The core wire 13 comes into contact with the guiding portions 36 of the slide member 31 and is guided into the slide member 31. If the wire 11 is pushed further forward, the front end part of the core wire 13 enters the inside of the terminal body 21 and reaches a space between the upper and lower connection pieces 25A, 25B.

If the wire 11 is pushed further forward, the front end part of the core wire 13 reaches a position below the terminal window portion 23 of the terminal body 21. If the front end part of the core wire 13 reaches this position, the front end part can be detected visually or by means of a probe or the like in the detectable terminal window portion 23 through the connector window portion 42. In this state, the insulation coating 14 of the wire 11 is located behind the guiding inclined surface 62 in the insertion hole 61 of the rear holder 50.

With the slide member 31 held at the partial locking position with respect to the terminal body 21 and the rear holder 50 held at the partial locking position with respect to the connector housing 40, the interval between the upper and lower connection pieces 25A, 25B is set larger than the outer diameter of the core wire 13. Thus, the core wire 13 is smoothly inserted into between the upper and lower connection pieces 25A, 25B.

Subsequently, the jig T is brought into contact with the jig contact portion 33 of the slide member 31 from behind through the connector window portion 42 to move the slide member 31 forward. In the terminal 20 accommodated in the accommodating portion 41, the front end corner part of the tube portion 22 is in contact with the recess 41A provided in the front end part of the accommodating portion 41 to restrict a forward movement of the terminal body 21. Thus, by being moved forward, the slide member 31 moves with respect to the terminal body 21. In this way, locking between the locking projections 27 of the terminal body 21 and the partial lock receiving portions 34 of the slide member 31 is released and the side walls of the slide member 31 ride on the locking projections 27 and are expanded and deformed. If the slide member 31 is pushed further forward by the jig T, the locking projections 27 of the terminal body 21 and the full locking receiving portions 35 of the slide member 31 are resiliently locked and the side walls of the slide member 31 are restored and deformed. In this way, the slide member 31 is held at the full locking position with respect to the terminal body 21 (see FIG. 4 and the like).

As shown in FIG. 3, with the slide member 31 held at the full locking position with respect to the terminal body 21, the upper connection piece 25A is bent downward by the upper pressurizing portion 32A of the slide member 31 pressing the upper connection piece 25A from above. Further, the lower connection piece 25B is bent upward by the lower pressurizing portion 32B of the slide member 31 pressing the lower connection piece 25B from below. In this way, the core wire 13 is vertically sandwiched by the upper and lower connection pieces 25A, 25B. The core wire 13 is held in a state extending in the front-rear direction and bent in the vertical direction by being sandwiched by the upper holding protrusion 25AP of the upper connection piece 25A and the lower holding protrusion 25BP of the lower connection piece 25B. At this time, the lower surface of the upper holding protrusion 25AP and the upper surface of the lower holding protrusion 25B are pressed against the core wire 13 and an oxide film formed on the surface of the core wire 13 is peeled off, whereby a metal surface constituting the core wire 13 is exposed. By the contact of this metal surface and the upper and lower connection pieces 25A, 25B, the wire 11 and the terminal 20 are electrically connected. Further, corner parts and the like of the upper and lower holding protrusions 25AP, 25BP bite into the core wire 13, whereby the core wire 13 is firmly held in the terminal 20.

Subsequently, the rear holder 50 is pushed forward. The lock receiving portions 57 of the rear holder 50 ride on the full locking portions 46 of the connector housing 40 and are expanded and deformed. If the rear holder 50 is pushed further forward, the full locking portions 46 of the connector housing 40 are locked to the lock receiving portions 57 of the rear holder 50 and the lock receiving portions 57 are restored and deformed. In the above way, the rear holder 50 is held at the full locking position with respect to the connector housing 40 (see FIG. 1 and the like) and the assembly of the connector 10 is completed.

### Exchange Process of Terminal 20 in Connector 10

Next, an example of an exchange process of the terminal 20 or the like in the connector 10 according to this embodiment is described. The exchange process of the terminal 20 or the like in the connector 10 is not limited to the one described below.

As shown in FIG. 3, in the connector 10, the hole diameter (diameter) of the insertion hole 61 at the position forward of the guiding inclined surface 62 is smaller than the diameter of the wire 11 including the insulation coating 14. With the core wire 13 connected to the terminal 20, the insulation coating 14 is located rearward of the guiding inclined surface 62. Thus, if an attempt is made to move the rear holder 50 rearward with the core wires 13 connected to the terminals 20, the insulation coatings 14 may be caught by the wall surfaces of the insertion holes 61 including the guiding inclined surfaces 62 and the rear holder 50 may be not removed from the connector housing 40.

Accordingly, in exchanging the terminal 20 after the wire 11 is connected in the connector 10, the hinge portion 51 is bent and the lid portion 52 in the front end part of the rear holder 50 is open upward or downward (see FIG. 8). In this way, a part (core wire 13) of the wire 11 held in the insertion hole 61 is exposed upward or downward (in the intersecting direction).

Subsequently, the exposed core wire 13 is cut from above or below the connector 10. The wire 11 separated from the terminal 20 is pulled out rearward from the rear holder 50 through the rear opening 61B. On the other hand, the terminal 20 is moved rearward, using the front end part of the insertion hole 61 opened upward or downward by moving the lid-side wall portion 52A, and taken out upward or downward through the connector window portion 42.

A new terminal 20 in which a terminal body 21 and a slide member 31 are held at the partial locking position and a new wire 11 having a core wire 13 exposed over a predetermined length are prepared.

The new terminal 20 is fit into the accommodating portion 41 having the terminal 20 and the wire 11 taken out therefrom through the connector window portion 42 and accommodated at a predetermined position by being moved forward with the lid portion 52 of the rear holder 50 opened.

After the new terminal 20 is accommodated, the opened lid portion 52 is closed and a front end part of the new wire 11 is inserted into the insertion hole 61 through the rear opening 61B in the rear end part of the rear holder 50 from behind the rear holder 50. The core wire 13 is brought into the space between the upper and lower connection pieces 25A, 25B by further pushing the wire 11, the slide member 31 is moved to the full locking position with respect to the terminal body 21 in the same procedure as described above, and the wire 11 is connected to the terminal 20. In the above way, the exchange of the terminal 20 and the wire 11 is completed without removing the rear holder 50 from the connector housing 40.

### Functions and Effects of Embodiment

Next, functions and effects of this embodiment are described.

The connector 10 according to this embodiment is provided with the terminals 20 to be connected to the front end parts of the wires 11 extending in the front-rear direction, the connector housing 40 including the accommodating portions 41 for accommodating the terminals 20, and the rear holder 50 to be mounted on the rear end part of the connector housing 40 in the extending direction of the wires 11. The rear holder 50 is formed with the insertion holes 61 each extending along the extending direction between the communication opening 61A communicating with the accommodating portion 41 and the rear opening 61B open to outside in the rear end part of the rear holder 50, and the guiding inclined surface 62 for reducing the hole diameter of the insertion hole 61 toward the communication opening 61A is provided on the wall surface of the insertion hole 61.

According to the configuration of this embodiment, in the case of inserting and connecting the wire 11 to the terminal 20 accommodated in the accommodating portion 41 of the connector housing 40 through the insertion hole 61 of the rear holder 50, the wire 11 inserted into the insertion hole 61 through the rear opening 61B of the rear holder 50 can be smoothly introduced into the terminal 20 through the communication opening 61A by the guiding inclined surface 62. As a result, the efficiency of an operation of inserting the wire 11 into the terminal 20 is improved.

Further, in the connector 10 according to this embodiment, the rear holder 50 includes the lid portions 52 capable of opening and closing the insertion holes 61 in the intersecting direction intersecting the extending direction and the holder body portions 55 forming the insertion holes 61 together with the lid portions 52 with the lid portions 52 closed.

According to the configuration of this embodiment, by opening the lid portion 52 to allow the insertion holes 61 to at least partially communicate with outside in the intersecting direction when needed while normally closing the lid portion 52 to protect the wires 11 in the insertion holes 61, the cutting, repair or the like of the wires 11 disposed in the insertion holes 61 can be performed from the intersecting direction. Since the hole diameter of the insertion hole 61 in front of the guiding inclined surface 62 is smaller than the diameter of the wire 11 including the insulation coating 14 in the connector 10 according to this embodiment, it may be difficult to move the rear holder 50 rearward with respect to the connector housing 40 after the wires 11 are connected to the terminals 20 in the accommodating portions 41. Even in such a case, it is possible to separate the terminal 20 and the wire 11 by opening the lid portion 52 of the rear holder 50 and cutting the wire 11 from the intersecting direction and pull out the wire 11 rearward from the rear holder 50.

Further, in the connector 10 according to this embodiment, the rear ends 20A of the terminals 20 accommodated in the accommodating portions 41 are covered by the lid portion 52 with the lid portion 52 closed, the rear ends 20A of the terminals 20 accommodated in the accommodating portions 41 are exposed in the intersecting direction with the lid portion 52 opened, and the terminals 20 are accommodated in the accommodating portions 41 removably in the intersecting direction with the lid portion 52 opened.

According to the configuration of this embodiment, connected parts of the terminals 20 and the wires 11 can be normally protected by closing the lid portion 52, whereas the lid portion 52 can be opened and the terminal 20 cut off from the wire 11 can be taken out in the intersecting direction when needed. As a result, each of the terminals 20 and the wires 11 can be easily taken out from the connector 10 and the terminal or wire can be exchanged or repaired.

Further, in the connector 10 according to this embodiment, the lid portion 52 is coupled to the holder body portion 55 by the hinge portion 51.

According to the configuration of this embodiment, the lid portion 52 can be easily opened and closed if necessary while a loss or position shift of the lid portion 52 is suppressed by a simple configuration.

Further, in the connector 10 according to this embodiment, the lid portion 52 includes the lid-side wall portions 52A each constituting a part of the wall surface of the insertion hole 61 with the lid portion 52 closed, the holder body portion 55 includes the body-side wall portions 55A each constituting the wall surface of the insertion hole 61 together with the lid-side wall portion 52A with the lid portion 52 closed, and one of the lid portion 52 or the holder body portion 55 is formed with the wall receiving portions 55B into which the body-side wall portions 55A or lid-side wall portions 52A are press-fit with the lid portion 52 closed.

According to the configuration of this embodiment, the body-side wall portions 55A or lid-side wall portions 52A are press-fit into the wall receiving portions 55B, whereby the lid portion 52 can be stably maintained in the closed state even without separately providing a locking mechanism.

### Other Embodiment

The present disclosure is not limited to the above described and illustrated embodiment. For example, the following embodiments are also included in the technical scope of the technique disclosed in this specification.

(1) In the above embodiment, the connector 10 is described which accommodates the terminal 20 provided with the terminal body 21 and the slide member 31. If such a terminal 20 is used, the wire 11 can be connected to the terminal 20 by a simple and compact configuration. This technique is particularly useful in the connector 10 provided with this terminal 20. That is, this technique is useful in a connector configured to insert and connect a wire to a terminal accommodated in an accommodating portion of a connector housing through a rear holder. However, the structure of the terminal to be accommodated into the connector according to this technique is not particularly limited and this technique is applicable to connectors for accommodating terminals having various structures.

(2) In the above embodiment, the connector 10 is described which accommodates the plurality of terminals 20. However, the number of the terminals to be accommodated into the connector according to this technique is not particularly limited and this technique is applicable also to a connector for accommodating only one terminal. Further, if a connector accommodates a plurality of terminals, all of a plurality of insertion holes provided in a rear holder may have a configuration according to this technique or only some of the plurality of insertion holes may have the configuration according to this technique.

For example, in the above embodiment, the lid-side wall portions or body-side wall portions constituting the wall surfaces of the insertion holes may be press-fit into the wall receiving portions in all of the plurality of insertion holes. By doing so, the lid portion can be stably maintained in the closed state. However, limitation to such a configuration is not necessary and, for example, the lid-side wall portions or body-side wall portions may be press-fit into the wall receiving portions in only some insertion holes provided at fixed intervals. By doing so, the lid portion can be maintained in the closed state while the structure is simplified. Alternatively, the lid-side wall portions may be press-fit into the wall receiving portions provided in the holder body portion in some insertion holes, out of the plurality of insertion holes, and the body-side wall portions may be press-fit into the wall receiving portions provided in the lid portion in some of the other insertion holes.

List of Reference Numerals

| | |
|---|---|
| 10: | connector |
| 11: | wire |
| 13: | core wire |
| 14: | insulation coating |
| 20: | terminal |
| 20A: | rear end (of terminal) |
| 21: | terminal body |
| 22: | tube portion |
| 23: | terminal window portion |
| 24: | base portion |
| 25: | connecting portion |
| 25A: | upper connection piece |
| 25AP: | upper holding protrusion |
| 25B: | lower connection piece |
| 25BP: | lower holding protrusion |
| 27: | locking projection |
| 31: | slide member |
| 32A: | upper pressurizing portion |
| 32B: | lower pressurizing portion |
| 33: | jig contact portion |
| 34: | partial lock receiving portion |
| 35: | full lock receiving portion |
| 36: | guiding portion |
| 40: | connector housing |
| 41: | accommodating portion |
| 41A: | recess |
| 42: | connector window portion |
| 43: | separation wall |
| 44: | partition wall |
| 45: | partial locking portion |
| 46: | full locking portion |
| 50: | rear holder |
| 51: | hinge portion |
| 52: | lid portion |
| 52A: | lid-side wall portion |
| 52B: | receptacle |
| 53: | rear hinge portion |
| 54: | rear lid portion |
| 55: | holder body portion |
| 55A: | body-side wall portion |
| 55B: | wall receiving portion |
| 57: | lock receiving portion |
| 58: | rear lid lock portion |
| 59: | rear lid lock receiving portion |
| 61: | insertion hole |
| 61A: | communication opening |
| 61B: | rear opening |
| 62: | guiding inclined surface |
| T: | jig |

1. A connector, comprising:
a terminal to be connected to a front end part of a wire extending in a front-rear direction;
a connector housing including an accommodating portion for accommodating the terminal; and
a rear holder to be mounted on a rear end part of the connector housing,
the rear holder being formed with an insertion hole extending along an extending direction of the wire between a communication opening communicating with the accommodating portion and a rear opening open to outside in a rear end part of the rear holder, and
a guiding inclined surface for reducing a hole diameter of the insertion hole toward the communication opening being provided on a wall surface of the insertion hole.

2. The connector of claim 1, wherein the rear holder includes:
a lid portion capable of opening and closing the insertion hole in an intersecting direction intersecting the extending direction; and
a holder body portion for forming the insertion hole together with the lid portion with the lid portion closed.

3. The connector of claim 2, wherein:
a rear end of the terminal accommodated in the accommodating portion is covered by the lid portion with the lid portion closed and is exposed in the intersecting direction with the lid portion opened, and
the terminal is accommodated in the accommodating portion removably in the intersecting direction with the lid portion opened.

4. The connector of claim 2, wherein the lid portion is coupled to the holder body portion by a hinge portion.

5. The connector of claim 2, wherein:
the lid portion includes a lid-side wall portion constituting a part of the wall surface of the insertion hole with the lid portion closed,
the holder body portion includes a body-side wall portion constituting the wall surface of the insertion hole together with the lid-side wall portion with the lid portion closed, and
one of the lid portion or the holder body portion is formed with a wall receiving portion, the body-side wall portion or the lid-side wall portion being press-fit into the wall receiving portion with the lid portion closed.
